(19) United States
(12) Patent Application Publication
(10) Pub. No.: US 2014/0037853 A1
(43) Pub. Date: Feb. 6, 2014

(54) DEPOSITING THIN LAYER OF MATERIAL ON PERMEABLE SUBSTRATE

(71) Applicant: Veeco ALD Inc., Fremont, CA (US)

(72) Inventor: Sang In Lee, Sunnyvale, CA (US)

(73) Assignee: Veeco ALD Inc., Fremont, CA (US)

(21) Appl. No.: 14/054,384

(22) Filed: Oct. 15, 2013

Related U.S. Application Data
(63) Continuation-in-part of application No. 13/372,290, filed on Feb. 13, 2012.
(60) Provisional application No. 61/444,658, filed on Feb. 18, 2011.

(51) Int. Cl. B05D 7/00; B05D 1/02

(52) U.S. Cl. CPC B05D 7/00; B05D 1/02
USPC 427/421.1; 118/313

(57) ABSTRACT

Embodiments relate to depositing a layer of material on a permeable substrate by passing the permeable substrate between a set of reactors. The reactors may inject source precursor, reactant precursor, purge gas or a combination thereof onto the permeable substrate as the permeable substrate passes between the reactors. Part of the gas injected by a reactor penetrates the permeable substrate and is discharged by the other reactor. The remaining gas injected by the reactor moves in parallel to the surface of the permeable substrate and is discharged via an exhaust portion formed on the same reactor.

### CROSS-REFERENCE TO RELATED APPLICATION

This application is a continuation-in-part of co-pending U.S. patent application Ser. No. 13/372,290 filed on Feb. 13, 2012, which claims priority under 35 U.S.C. §119(e) to U.S. Provisional Patent Application No. 61/444,658, filed on Feb. 18, 2011, which are incorporated by reference herein in their entirety.

### BACKGROUND

1. Field of Art

The disclosure relates to depositing one or more layers of materials on a permeable substrate by injecting precursor onto the permeable substrate.

2. Description of the Related Art

Permeable substrates such as membrane and fabric have various applications. The permeable substrates may be deposited with certain materials to enhance or modify various characteristics of the substrates. For example, some applications require high melting point and high strength in the permeable substrates. To obtain the desired characteristics, the permeable substrates may be deposited with materials that have a melting point and strength higher than the permeable substrates.

Applications of permeable substrates include their use as separators in rechargeable batteries (e.g., Lithium-ion battery). Such separators are often formed by depositing powder onto a porous polyethylene membrane. The polyethylene membrane generally has a thickness about 25 μm or less, pore size less than 1 μm and porosity of about 40% or less. By depositing powder (e.g., Al₂O₃) onto the polyethylene membrane, the polyethylene membrane may retain its shape even in a high temperature. In order to prevent premature melting of the polyethylene membrane due to insufficient coating, the power is coated to a significant thickness on the polyethylene membrane. Due to the thickness of the membrane, the packing density of the rechargeable is decreased (i.e., the size of the battery is increased).

In other applications such as facial tissue or diaper, water resistant is required in addition to high strength and melting point. Such characteristics can be achieved by depositing oxide such as Al₂O₃ or TiO₂, nitride such as SiN and carbon material such as graphene onto paper to a thickness in the range of several tens of angstroms or several hundreds of angstroms.

The cost or time associated with the depositing the material onto the substrate may be significant, increasing the overall cost of time associated with fabricating the permeable substrate. Moreover, the quality of the deposited materials may be lower than desired, decreasing the quality of products or increasing the amount of permeable substrates needed in the products.

### SUMMARY

Embodiments relate to depositing material on a permeable substrate by injecting a first precursor onto a surface of the permeable substrate using a first module and discharging part of the first precursor by the first module while discharging another part of the first precursor by a second module. The module is placed at one side of the permeable substrate and formed with a reaction chamber for injecting the first precursor and a first exhaust portion for discharging a first portion of the first precursor flowing along the surface of the permeable substrate. The second module is placed at the other side of the permeable substrate and is formed with a second exhaust portion for discharging a second portion the first precursor penetrating through the permeable substrate.

In one embodiment, the pressure of the first exhaust portion relative to the pressure of the second exhaust portion is controlled to adjust first thickness of material deposited on the surface of the substrate relative to second thickness of the material deposited on pores or holes of the substrate.

In one embodiment, the pressure of the first exhaust portion is set higher than the pressure of the second exhaust portion.

In one embodiment, the deposition device further includes a third module placed adjacent to the first reactor. The third module injects a second precursor that reacts with the first precursor onto the surface of the permeable substrate to deposit material. The third module is formed with a third exhaust portion for discharging a first portion of the second precursor flowing along the surface of the permeable substrate.

In one embodiment, the deposition device further includes a fourth module placed at the other side of the permeable substrate. The fourth module is formed with a fourth exhaust portion for discharging a second portion of the second precursor penetrating through pores or holes of the substrate. The pressure at the third exhaust portion relative to pressure at the fourth exhaust portion is controlled to adjust first thickness of the material deposited on the surface of the substrate relative to second thickness of the material deposited on the pores or holes of the substrate.

In one embodiment, the deposition device further includes a third module placed at the other side of the permeable substrate to inject a second precursor that reacts with the first precursor onto the other surface of the permeable substrate to deposit material. The third module is formed with a third exhaust portion configured to discharge a first portion of the second precursor flowing along the other surface of the permeable substrate.

In one embodiment, the deposition device includes a fourth module placed adjacent to the first module. The fourth module is formed with a fourth exhaust portion for discharging a second portion of the second precursor penetrating through pores or holes of the substrate. The pressure at the third exhaust portion relative to pressure at the fourth exhaust portion is controlled to adjust first thickness of the material deposited on the surface of the substrate relative to second thickness of the material deposited on the pores or holes of the substrate.

In one embodiment, the deposition device includes mechanism for causing relative movement between the permeable substrate and the first and second modules.

In one embodiment, the first module is formed with a constriction zone between the reaction chamber and the first exhaust portion. The constriction zone has a height less than ⅔ of the height of the reaction chamber.

In one embodiment, the second module is formed with another reaction chamber for injecting the first precursor onto another surface of the permeable substrate.

In one embodiment, the pressure at the first exhaust portion and the pressure at the second exhaust portion are controlled to deposit material of different thickness along depths of pores or holes in the permeable substrate.

### BRIEF DESCRIPTION OF DRAWINGS

Figure (FIG.) 1 is a perspective view of a deposition device, according to one embodiment.

FIG. 2 is a cross sectional view of the deposition device of FIG. 1 taken along line A-B, according to one embodiment.

FIG. 3 is a perspective view of the deposition device of FIG. 1 cut in half, according to one embodiment.

FIG. 4 is a diagram illustrating flow of precursor material below a source injector, according to one embodiment.

FIG. 5A is a cross sectional view of a deposition device including radical reactors, according to one embodiment.

FIG. 5B is a cross sectional view of a deposition device including a radical reactor, according to another embodiment.

FIG. 5C is a cross sectional view of a deposition device with injectors and radical reactors placed in an alternating manner, according to one embodiment.

FIG. 5D is a cross sectional view of a deposition device with injectors and radical reactors placed in an alternating manner, according to another embodiment.

FIG. 6 is a flowchart illustrating a process of performing deposition, according to one embodiment.

FIG. 7 is a cross sectional view of a deposition device with a lower reactor that is movable relative to an upper reactor, according to one embodiment.

### DETAILED DESCRIPTION OF EMBODIMENTS

Embodiments are described herein with reference to the accompanying drawings. Principles disclosed herein may, however, be embodied in many different forms and should not be construed as being limited to the embodiments set forth herein. In the description, details of well-known features and techniques may be omitted to avoid unnecessarily obscuring the features of the embodiments.

In the drawings, like reference numerals in the drawings denote like elements. The shape, size and regions, and the like, of the drawing may be exaggerated for clarity.

Embodiments relate to depositing a layer of material on a permeable substrate by passing the permeable substrate between a set of reactors. The reactors may inject source precursor, reactant precursor, purge gas or a combination thereof onto the permeable substrate as the permeable substrate passes between the reactors. Part of the gas injected by a reactor penetrates the permeable substrate and is discharged by the other reactor. The remaining gas injected by the reactor moves in parallel to the surface of the permeable substrate and is discharged via an exhaust portion formed on the same reactor. While penetrating the substrate or moving in parallel to the surface, the source precursor or the reactant precursor becomes absorbed on the substrate or react with precursor already present on the substrate.

Permeable substrate described herein refers to a substrate having a planar structure where at least part of gases or liquids injected on one side of the substrate can penetrate to the opposite side of the substrate. The permeable substrate includes, among others, textile, membrane and fabric, and web. The permeable structure may be made of various materials including, among other materials, paper, polyethylene, porous metal, wool, cotton and flax.

Figure (FIG.) 1 is a perspective view of a deposition device 100, according to one embodiment. The deposition device 100 may include, among other components, an upper reactor 130A and a lower reactor 130B. A permeable substrate 120 moves from the left to right (as indicated by arrow 114) and passes between the upper and lower reactors 130A, 130B, the permeable substrate 120 is deposited with a layer 140 of material. The entire deposition device 100 may be enclosed in a vacuum or in a pressurized vessel. Although the deposition device 100 is illustrated as depositing material on the substrate 120 as the substrate moves horizontally, the deposition device 100 may be oriented so that the layer 140 is deposited as the substrate 120 moves vertically or in a different direction.

The upper reactor 130A is connected to pipes 142A, 146A, 148A supplying precursor, purge gas and a combination thereof into the upper reactor 130A. Exhaust pipes 152A and 154A are also connected to the upper reactor 130A to discharge excess precursor and purge gas from the interior of the upper reactor 130A. The upper reactor 130A has its lower surface facing the substrate 120.

The lower reactor 130B is also connected to pipes 142B, 146B, 148A to receive precursor, purge gas and a combination thereof. Exhaust pipes (e.g., pipe 154B) are also connected to the lower reactor 130B to discharge excess precursor and purge gas from the interior of the lower reactor 130B. The lower reactor 130B has it upper surface facing the substrate 120.

The deposition device 100 may perform atomic layer deposition (ALD), molecular layer deposition (MLD) or chemical vapor deposition (CVD) on the substrate 120 as the substrates moves from the left to the right between the lower surface of the upper reactor 130A and the upper surface of the lower reactor 130B. ALD is performed by injecting source precursor on the substrate followed by reactant precursor on the substrate. The MLD is substantially the same as ALD except that a hybrid polymer is formed on the substrate. In CVD, the source precursor and the reactant precursor is mixed before injection onto the substrate 120. The deposition device 100 may perform one or more of ALD, MLD or CVD based on gases supplied to the reactors 130A, 130B and other operating conditions.

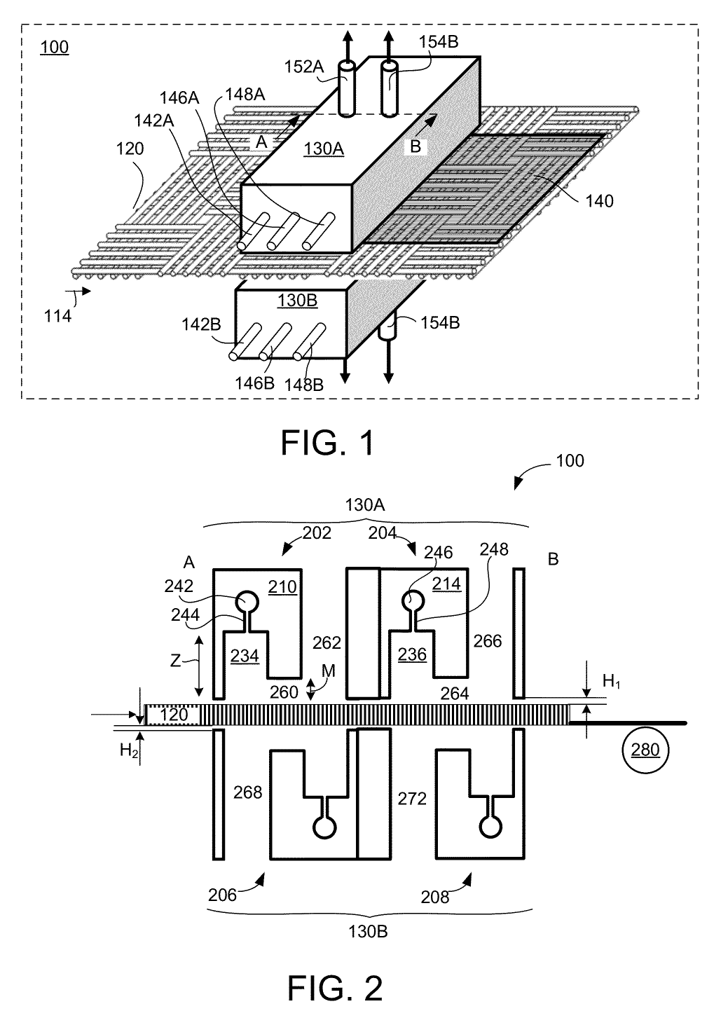

FIG. 2 is a cross sectional view of the deposition device 100 taken along line A-B of FIG. 1, according to one embodiment. The upper reactor 130A may include, among other components, a source injector 202 and a reactant injector 204. The source injector 202 is connected to the pipe 142A to receive the source precursor (in combination with carrier gas such as Argon) and the reactant injector 204 is connected to the pipe 148A to receive reactant precursor (in combination with carrier gas such as Argon). The carrier gas may be injected via a separate pipe (e.g., pipe 146A) or via the pipes that supply the source or reactant precursor.

The body 210 of the source injector 202 is formed with a channel 242, perforations (e.g., holes or slits) 244, a reaction chamber 234, a constriction zone 260 and an exhaust portion 262. The source precursor flows into the reaction chamber 234 via the channel 242 and the perforations 244, and reacts with the permeable substrate 120. Part of the source precursor penetrates the substrate 120 and is discharged via an exhaust portion 268 formed on the lower reactor 130B. The remaining source precursor flows through the constriction zone 260 in parallel to the surface of the substrate 120 and is discharged into the exhaust portion 262. The exhaust portion is connected to the pipe 152A and discharges the excess source precursor out of the injector 202.

When the source precursor flows through the constriction zone 260, excess source precursor is removed from the surface of the substrate 120 due to the higher speed of the source precursor in the construction zone 260. In one embodiment, the height M of the constriction zone 260 is less than ⅔ the height Z of the reaction chamber 234. Such height M is desirable to remove the source precursor from the surface of the substrate 120.

The reactant injector 204 has a similar structure as the source injector 202. The reactant injector 204 receives the reactant precursor and injects the reactant precursor onto the substrate 120. The source injector 204 has a body 214 formed with a channel 246, perforations 248, a reaction chamber 236, a constriction zone 264 and an exhaust portion 266. The functions and the structures of these portions of the reactant injector 204 are substantially the same as counterpart portions of the source injector 202. The exhaust portion 266 is connected to the pipe 154B.

The lower reactor 130B has a similar structure as the upper reactor 130A but has an upper surface facing a direction opposite to the upper reactor 130A. The lower reactor 130B may include a source injector 206 and a reactor injector 208. The source injector 206 receives the source precursor via the pipe 142B and injects the source precursor onto the rear surface of the substrate 120. Part of the source precursor penetrates the substrate 120 and is discharged via the exhaust portion 262. The remaining source precursor flows into the exhaust portion 268 in parallel to the surface of the substrate 120 and is discharged from the source injector.

The structure of the reactor injector 208 is substantially the same as the reactor injector 204, and therefore, detailed description thereof is omitted herein for the sake of brevity.

The deposition device 100 may also include a mechanism 280 for moving the substrate 120. The mechanism 280 may include a motor or an actuator that pulls or pushes the substrate 120 to the right direction as illustrated in FIG. 2. As the substrate 120 is move progressively to the right, substantially entire surface of the substrate 120 is exposed to the source precursor and the reactant precursor, depositing material on the substrate 120 as a result.

By having an opposing set of reactors, the source precursor and the reactant precursor flow perpendicular to the surface of the substrate 120 as well as in parallel to the surface of the substrate 120. Therefore, a layer of conformal material is deposited on the flat surface as well as the pores or holes in the substrate 120. Hence, the material is deposited more evenly and completely on the substrate 120.

In order to reduce the precursor material leaked outside the deposition device, the distances H₁, H₂ between the substrate 120 and the upper/lower reactor 130A, 130B are maintained at low values. In one embodiment, the distances H₁ and H₂ are less than 1 mm, and more preferably less than tens of μms.

In one embodiment, the relative thickness of amount of material deposited on the top or bottom of the substrate 120 and the pores or holes in the substrate 120 is controlled by the pressure in the exhaust portions 262, 266, 268, 272 or the amount of gas passing through the exhaust portions 262, 266, 268, 272.

Taking an example of lowering the pressure at the exhaust portion 268 relative to the pressure at the exhaust portion 262, more source precursor from the reaction chamber 234 passes through the pores or holes of the substrate 120 and is discharged via the exhaust portion 268 while less source precursor passes through the constriction zone 260 and is discharged via the exhaust portion 262. The source precursor injected by the injector 206 is also mostly discharged by the exhaust portion 268 instead of the exhaust portion 262. Therefore, the bottom surface of the substrate 120 and the pores or holes of the substrate 120 tends to be injected with more source precursor than the top surface of the substrate 120.

If the exhaust portion 272 is placed at a lower pressure than the exhaust portion 266, more reactant precursor will also be injected on the bottom surface of the substrate 120 and the pores or holes of the substrate 120, resulting in a thicker deposition of material on the bottom surface of the substrate 120 and the pores or holes of the substrate 120 than on the top surface of the substrate 120. By controlling the relative pressure at the exhaust portions 262, 266, 268, 272 or the amount of gas discharged via these exhaust portions, different parts of the substrate may be deposited with material of different thickness.

Instead of controlling the relative pressure at the exhaust portions, the distance H₁ and H₂ may be controlled to change the amount of material deposited on the surfaces and in the pores or holes of the substrate 120. For example, by increasing the distance H₂ relative to the distance H₁, more material may be deposited on the top surface of the substrate 120 than in the pores or holes of the substrate 120 or on the bottom surface of the substrate 120.

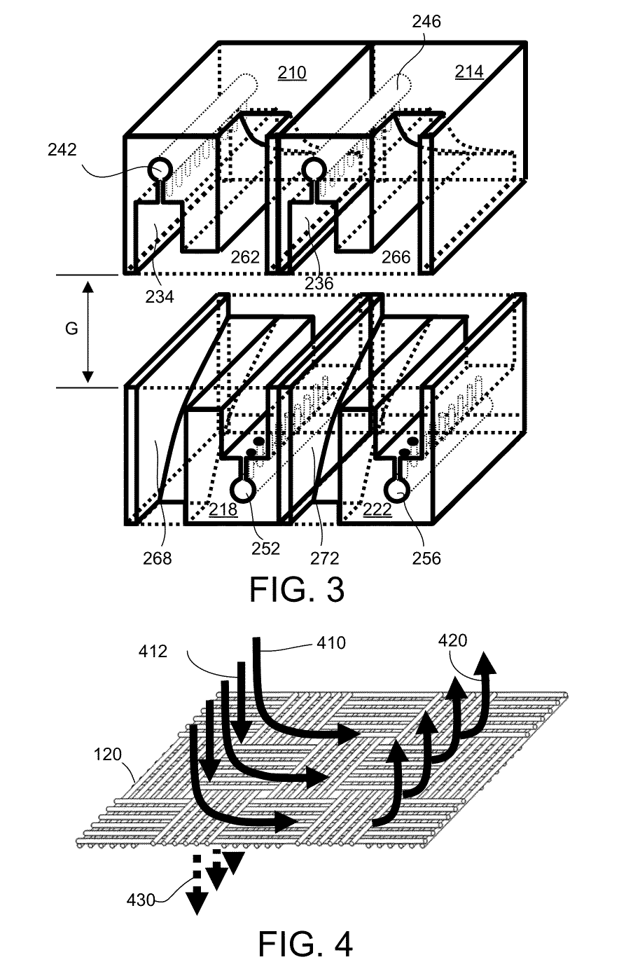

FIG. 3 is a perspective view of the deposition device 100 of FIG. 1 cut in half, according to one embodiment. As shown in FIG. 3, the exhaust portions 262, 266, 268, 272 have a curved interior surface to receive the excess source precursor and the excess reactant precursor across substantially the entire length of the deposition device 100. The upper reactor 130A and the lower reactor 130B are separated by distance G. The distance G is sufficient to enable the substrate 120 to pass between but not excessively large to allow precursor to leak out between the clearance between the substrate 120 and the reactors 130A, 130B.

FIG. 4 is a diagram illustrating flow of source precursor below a source injector 202, according to one embodiment. The source precursor is injected downward by the perforations 244 as shown by arrows 410, 412. Some of the source precursor moves in parallel to the upper surface of the substrate 120 as shown by arrow 410 and is then discharged via the exhaust portion 262 as indicated by arrow 420. The remaining source precursor flows down as shown by arrow 412, penetrates the substrate 120 and flows downwards through the exhaust portion 268 of the source injector 206. As shown in FIG. 4, the injected source precursor partially penetrates the substrate while the remaining source precursor flows along the substrate 120. In this way, the entire substrate 120 is absorbed with the source precursor. Although not illustrated, the reactant precursor also flows through the substrate 120 or flows along the surface of the substrate 120.

In one embodiment, trimethylaluminum (TMA) is used as the source precursor and O₃ is used as the reactant precursor to deposit Al₂O₃ on the substrate 120. In another embodiment, TMA is used as the source precursor and NH₃ is used as the reactant precursor to deposit AlN on the substrate 120. Various other combinations of source precursor and reactant precursor may be used to deposit different materials on the substrate 120.

In one embodiment, purge injectors for injecting purge gas (e.g., Argon gas) are provided between the source injectors and the reactant injectors. These purge injectors remove excess source precursor from the substrate and promote growth of a conformal layer on the surface of the substrate and pores of the substrate. Purge injectors may also be provided next to the reactant injectors to remove excess reactant precursor from the substrate.

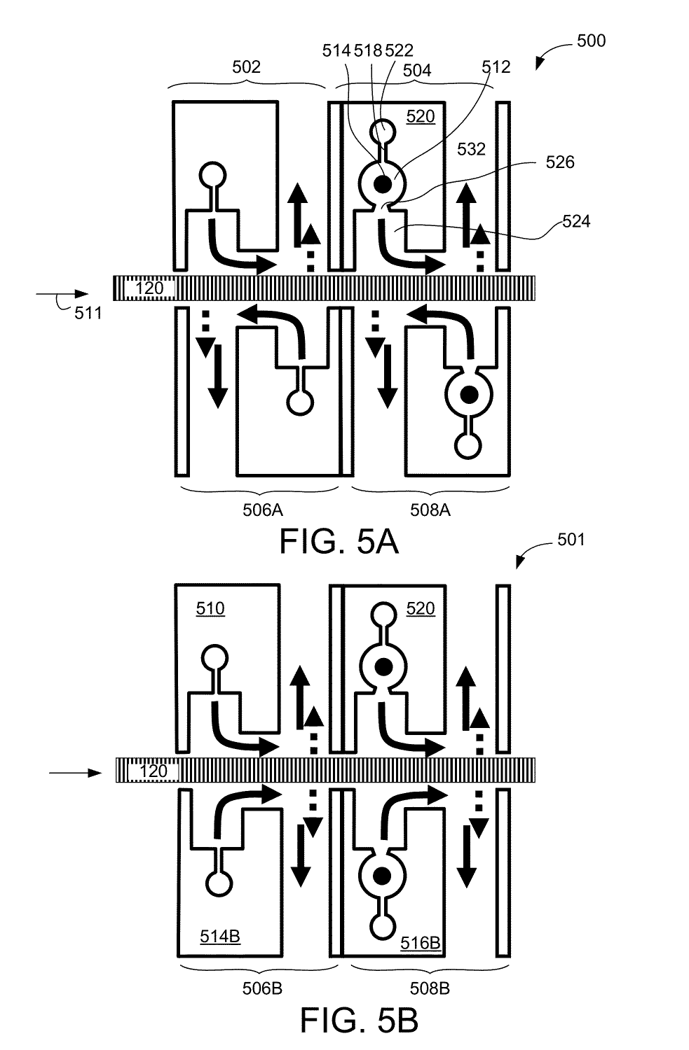

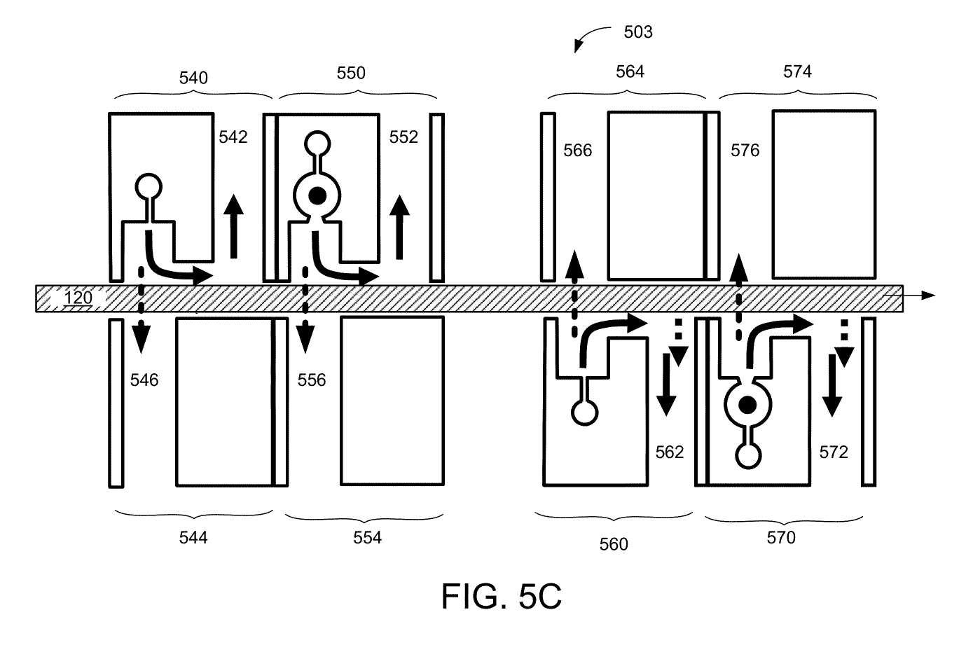

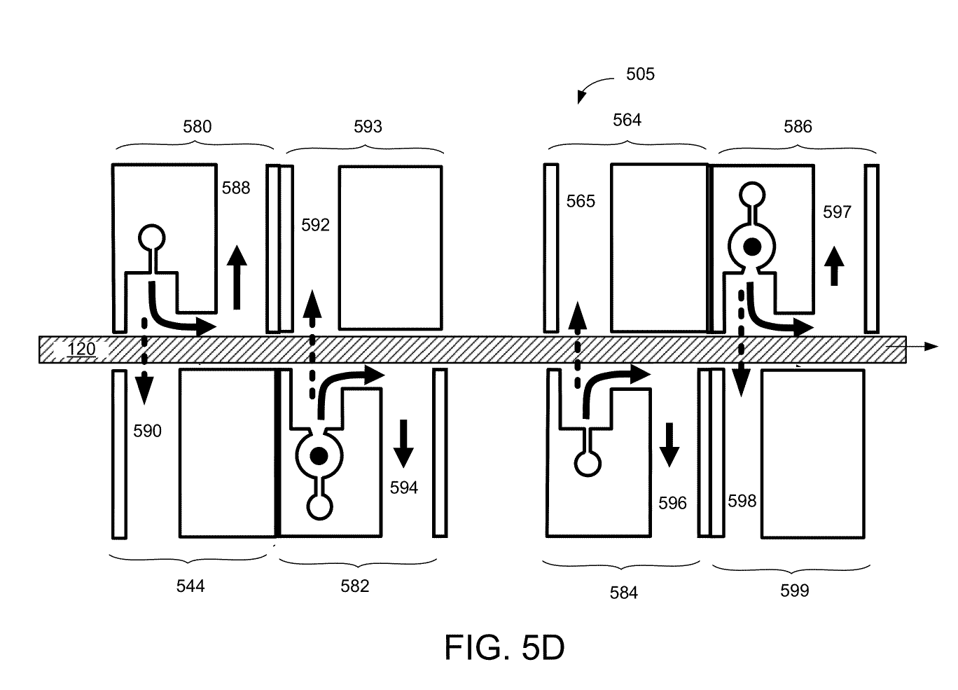

In one embodiment, radical reactors may be provided in the upper and lower reactors to inject radicals of gas as reactant precursor onto the substrate. FIG. 5A is a cross sectional view of a deposition device 500 including radical reactors 504, 508A, according to one embodiment. The deposition device 500 is substantially the same as the deposition device 100 except that the injectors 204, 208 are replaced with the radical reactors 504, 508A.

The deposition device 500 includes source injectors 502, 506A and the radical reactors 504, 508A. The structure and function of the source injectors 502, 506A are the same as the source injectors 202, 206, and therefore, the description thereof is omitted for the sake of brevity. The permeable substrate 120 moves from the left to the right as shown by arrow 511 in FIG. 5A so that the permeable substrate 120 is exposed first to the source precursor (by the source injectors 502, 506A) and then the radicals (by the radical reactors 504, 508A).

The radical reactor 504 may include, among other components, an inner electrode 514 and a body 520. The body 520 may be formed with, among other structures, a channel 522, perforations (e.g., holes or slits) 518, a plasma chamber 512, an injection holes 526, a reaction chamber 524 and an exhaust portion 532. Gas is provided into the plasma chamber 512 via the channel 522 and the perforations 518. Voltage difference is applied between the inner electrode 514 and the body 520 of the radical reactor 504 to generate plasma within the plasma chamber 512. The body 520 of the radical reactor 504 functions as an outer electrode. In an alternative embodiment, an outer electrode separate from the body 520 may be provided to surround the plasma chamber 512. As a result of generating the plasma, radicals of the gas is formed in the plasma chamber 512 and injected into the reaction chamber 524 via the injection holes 526.

As described above with reference to FIG. 4, part of the radicals generated by the radical reactors 504, 508A penetrate the substrate and are discharged by exhaust portions provided in the radical reactors of the opposite side. The other radicals flow in parallel to the surface of the substrate 120 and are discharged by the exhaust portions of the radical reactor that generated the radicals.

FIG. 5B is a cross sectional view of a deposition device 501 including radical reactors 520, 508B, according to another embodiment. The deposition device 501 is substantially the same as the deposition device 500 except that the orientation of the source injector 506B and the radical reactor 508B is opposite to the counterpart components of the deposition device 500.

FIG. 5C is a cross section view of a deposition device 503 with injectors 540, 560 and radical reactors 550, 570 placed in an alternating manner, according to one embodiment. The injectors 540, 560 are substantially the same as the injector 502, 506A except that the injectors 540, 560 are not placed at opposite sides of the substrate 120. Instead, exhaust blocks 544, 564 are placed at opposite sides of the injectors 540, 560. Similarly, the reactors 550, 570 are substantially the same as the reactors 504, 508A except that the reactors 550, 570 are not placed at opposite sides of the substrate 120. Instead, exhaust blocks 554, 574 are placed at opposite sides of the reactors 550, 570. The exhaust blocks 544, 554, 564, 574 are formed with exhaust portions 546, 556, 566, 576, respectively, to discharge source precursors or radicals.

The structure of the deposition device 503 is advantageous, among other reasons, because the amount of source precursor and the radicals injected onto the top surface, pores or holes and the bottom surface of the substrate 120 can be individually controlled. By decreasing the pressure at exhaust portion 546 relative to the pressure at exhaust portion 542, more source precursor passes through the holes or pores in the substrate 120 before being discharged via the exhaust portion 546 while less source precursor passes through a constriction zone and is discharged via the exhaust portion 542. Conversely, by decreasing the pressure at the exhaust portion 542 relative to the pressure at the exhaust portion 546, more source precursor passes the constriction zone and is discharged via the exhaust portion 542 while less source precursor passes through the holes or pores in the substrate 120 and is discharged via the exhaust portion 546. The same principle applies to the relative pressure at the exhaust portions 552, 556, the exhaust portions 566, 562, and the exhaust portions 576, 572. Hence, by controlling the relative pressure at the exhaust portions, the amount of source precursor injected through the pores or holes, on the top surface and on the bottom surface of the substrate 120 can be controlled. In this way, the relative amount of material deposited in the pores or holes, on the top surface and on the bottom surface of the substrate 120 can be controlled.

FIG. 5D is a cross section view of a deposition device 505 with injectors 580, 584 and radical reactors 582, 586 placed in an alternating manner, according to another embodiment. The deposition device 505 is substantially the same as the deposition device 503 except that the locations of reactors 582 and exhaust block 593 are switched, and the locations of reactor 586 and exhaust block 599 are switched compared to the counterpart components of the deposition device 503. The thicknesses of material deposited on the top, bottom surface and in the pores or holes of the substrate 120 may be controlled by adjusting pressure at exhaust portion 588 relative to pressure at exhaust portion 590, pressure at exhaust portion 592 relative to pressure at exhaust portion 584, pressure at exhaust portion 565 relative to pressure at exhaust portion 596, and/or pressure at exhaust portion 597 relative to pressure at exhaust portion 598.

In one embodiment, the source precursor injected by the source injectors 502, 506A, 506B, 540, 560, 580, 584 is trimethylaluminum (TMA) and the reactant precursor injected by the radical reactors 504, 508A, 508B, 550, 570, 582 or 586 are O* radicals. The deposited material is Al₂O₃, which affords water resistance to the permeable substrate.

In another embodiment, the source precursor injected by the source injectors 502, 506A, 506B, 540, 560, 580, 584 is trimethylaluminum (TMA) and the reactant precursor injected by the radical reactors 504, 508A, 508B, 550, 570, 582 or 586 is NH₃ radicals. The deposited material is AlN or AlON.

In another embodiments, dielectric material (e.g., SiN) or metal (e.g., TiN) layer are deposited on the substrate using combinations of source precursor and reactant precursor well known in the art. SiN or TiN layer advantageously affords water resistant or water repellent properties to the substrate.

In still another embodiment, Ag or AgO is deposited on the permeable substrate using combinations of source precursor and reactant precursor well known in the art. Ag or AgO layer affords anti-microbial properties to the substrate.

In yet another embodiment, graphene, amorphous carbon, diamond like carbon (DLC) or their combinations may be deposited on the substrate to increase the strength of the substrate as well as affording different functionality to the substrate.

In other embodiments, hybrid organic-inorganic layer (e.g., alucon having (Al—O—R—O)ₙ— structure)) may be deposited on hydrophilic substrate to afford water repellent properties. Conductive materials such as Al, Cu, TiN or Indium tin oxide (ITO) may also be deposited on the permeable substrate to fabricate conductive sheet or for reducing damages due to electrostatic shocks on electronic devices.

In one embodiment, the thickness of material deposited in the pores or holes of the substrate may be varied along the thickness of the pore or holes of the substrate by controlling the pressure of source precursor and/or reactant precursor at the exhaust portions. Taking the example of the deposition device 503, the pressure at the exhaust portions 542, 552 may be kept high relative to the pressure at the exhaust portions 546, 556 to expose the top surface and upper portions of the pores or holes of the substrate to more source precursor and radicals. The pressure at the exhaust portions 566, 576 may be kept high relative to the pressure at the exhaust portions 562, 572 or the amount of precursor materials injected by the injector 560 and the reactor 570 may be kept to a level less than the precursor material injected by the injector 540 and reactor 550. In this way, the material deposited on the top surface and the upper parts of the holes or pores of the substrate 120 tend to be thicker than the material deposited on the bottom surface and lower part of the holes or pores of the substrate 120. Therefore, by controlling the pressure profile at each exhaust portion, the thickness of material deposited on the holes or pores of the substrate 120 may be gradually increased or decreased along the depth of the holes or pores.

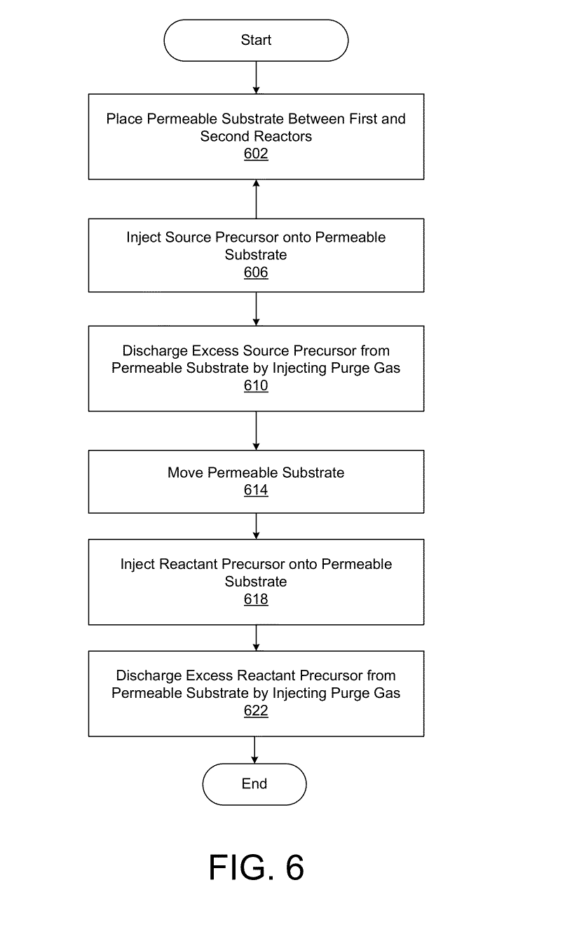

FIG. 6 is a flowchart for a process of depositing material on a permeable substrate, according to one embodiment. The permeable substrate is placed 602 between a first reactor (e.g., the upper reactor 130A) and a second reactor (e.g., the lower reactor 130B). The first reactor, the second reactor or both of the reactors inject 606 source precursor onto the substrate 120. Excess source precursor remaining after being absorbed by the substrate 120 is discharged 610 by the first reactor and the second reactor. The first reactor, the second reactor or both of the reactors may also inject purge gas to discharge excess source precursor from the substrate 120.

The substrate 120 is then moved 614 to place a portion of the substrate 120 previously injected with the source precursor to a location for injecting reactant precursor by the first reactor, the second reactor or both. The first reactor, the second reactor or both of the reactors inject 618 reactant precursor onto the substrate 120 to deposit a layer of material on the surface of the substrate 120 and in the pores of the substrate 120.

The first reactor, the second reactor or both of the reactors may also inject purge gas to discharge 622 excess reactant precursor from the permeable substrate.

The processes 602 through 622 may be repeated for a predetermined number of times to deposit a layer of materials of a predetermined thickness.

In above embodiments, the upper and lower reactors deposit the same material on the substrate. However, in other embodiments, each of the upper and lower reactors may inject different gases to deposit a different material on both sides of the substrate.

In one or more embodiment, the substrate deposited with the material may be subject to additional processes such as exposure to ultraviolet (UV) ray, microwave or magnetic field after, during or before being exposed to precursor molecules.

Depositing materials on permeable substrate using the embodiments is advantageous, among other reasons, because (i) the process can be performed at a low temperature (e.g., below 150° C.), (ii) the deposited material has strong adhesion to the substrate, and (iii) various processes (e.g., radical surface treatment) can be performed on the substrate in-situ without moving the substrate to a different device.

The substrate deposited with material using embodiments described herein may have higher melting point or retain its shape at a high temperature. The embodiments also results in a substrate with a conformal layer, enabling the substrate to be used as separators in rechargeable battery with higher packing density. Further, embodiments enable use of less precursor materials to deposit materials on the substrate, resulting in lower production cost.

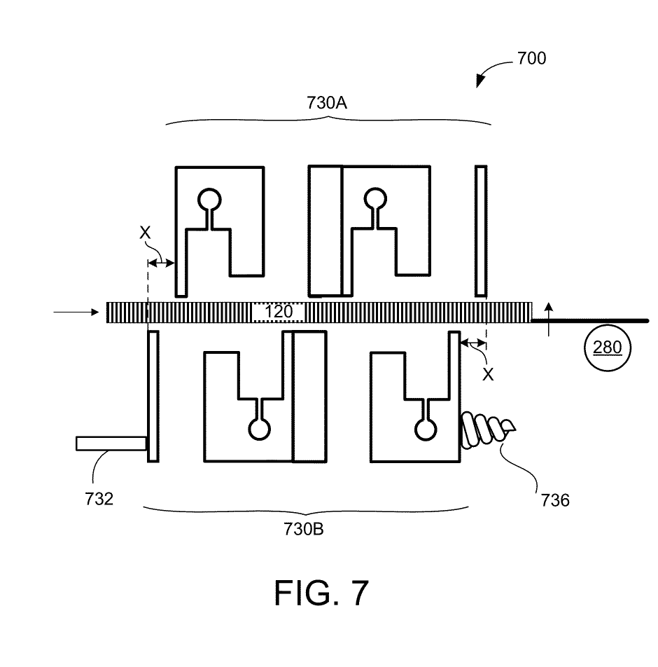

FIG. 7 is a cross sectional view of a deposition device 700 with a lower reactor 730B that is movable relative to an upper reactor 730A, according to one embodiment. The deposition device 700 is identical to the deposition device 100 except that the reactors 730A and 730B can move horizontally relative to each other. As shown in FIG. 7, for example, the lower reactor 730B may be moved left or right by a pushing rod 732 connected to the left end of the lower reactor 730B. A spring 736 may be placed at the right end of the lower reactor 730B to exert force onto the lower reactor 730B towards the left side.

By increasing the distance X representing the horizontal shifting of the lower reactor 730B relative to the upper reactor 730A, the amount of source or reactant gas injected by the upper reactor 730A passing through the permeable substrate 280 into an exhaust portion of the lower reactor 730B can be controlled. That is, the amount of source and/or reactant precursor penetrating through the permeable substrate 280 relative to the amount of source and/or reactant precursor flowing in parallel to the surface of the substrate is decreased as the distance X is increased. By controlling the distance X, the amount of material deposited in the pores or holes of the permeable substrate 120 relative to the top or bottom surface of the substrate 120 can be controlled.

Although FIG. 7 was described with reference to moving the lower reactor 730B while keeping the upper reactor 730A in a fixed position, the lower reactor 730B can be fixed while moving the upper reactor 730A. Alternatively, both the upper reactor 730A and the lower reactor 730B can be moved to adjust the relative amount of materials deposited on the top or bottom surfaces of the substrate and in the pores or holes of the substrate.

Although the present invention has been described above with respect to several embodiments, various modifications can be made within the scope of the present invention. Accordingly, the disclosure of the present invention is intended to be illustrative, but not limiting, of the scope of the invention, which is set forth in the following claims.

What is claimed is:

1. A deposition device for depositing material on a permeable substrate, comprising:
a first module placed at one side of the permeable substrate and formed with a reaction chamber configured to inject a first precursor onto a surface of the permeable substrate and a first exhaust portion configured to discharge a first portion of the first precursor flowing along the surface of the permeable substrate; and
a second module placed at another side of the permeable substrate and formed with a second exhaust portion configured to discharge a second portion the first precursor penetrating through the permeable substrate.

2. The deposition device of claim 1, wherein pressure of the first exhaust portion relative to pressure of the second exhaust portion is controlled to adjust first thickness of material deposited on the surface of the substrate relative to second thickness of the material deposited on pores or holes of the substrate.

3. The deposition device of claim 2, wherein the pressure of the first exhaust portion is set higher than the pressure of the second exhaust portion.

4. The deposition device of claim 1, further comprising a third module placed adjacent to the first reactor and configured to inject a second precursor that reacts with the first precursor onto the surface of the permeable substrate to deposit material, the third module formed with a third exhaust portion configured to discharge a first portion of the second precursor flowing along the surface of the permeable substrate.

5. The deposition device of claim 4, further comprising a fourth module placed at the other side of the permeable substrate and formed with a fourth exhaust portion configured to discharge a second portion of the second precursor penetrating through pores or holes of the substrate, wherein pressure at the third exhaust portion relative to pressure at the fourth exhaust portion is controlled to adjust first thickness of the material deposited on the surface of the substrate relative to second thickness of the material deposited on the pores or holes of the substrate.

6. The deposition device of claim 1, further comprising a third module placed at the other side of the permeable substrate to inject a second precursor that reacts with the first precursor onto the other surface of the permeable substrate to deposit material, the third module formed with a third exhaust portion configured to discharge a first portion of the second precursor flowing along the other surface of the permeable substrate.

7. The deposition device of claim 6, further comprising a fourth module placed adjacent to the first module and formed with a fourth exhaust portion configured to discharge a second portion of the second precursor penetrating through pores or holes of the substrate, wherein pressure at the third exhaust portion relative to pressure at the fourth exhaust portion is controlled to adjust first thickness of the material deposited on the surface of the substrate relative to second thickness of the material deposited on the pores or holes of the substrate.

8. The deposition device of claim 1, further comprising mechanism for causing relative movement between the permeable substrate and the first and second modules.

9. The deposition device of claim 1, wherein the first module is formed with a constriction zone between the reaction chamber and the first exhaust portion, the constriction zone having a height less than ⅔ of a height of the reaction chamber.

10. The deposition device of claim 1, wherein the second module is formed with another reaction chamber configured to inject the first precursor onto another surface of the permeable substrate.

11. The deposition device of claim 1, wherein the pressure at the first exhaust portion and the pressure at the second exhaust portion are controlled to deposit material of different thickness along depths of pores or holes in the permeable substrate.

12. The deposition device of claim 1, wherein locations of the first and second modules in a direction parallel to the permeable substrate are controlled to adjust a thickness of the material deposited in pores or holes of the permeable substrate relative to a thickness of the material deposited on the surface of the permeable substrate.

13. A method of depositing material on a permeable substrate, comprising:
injecting a first precursor onto a surface of the permeable substrate by a first module placed at one side of the permeable substrate;
discharging a first portion of the first precursor flowing along the surface of the permeable substrate by a first exhaust portion in the first module;
discharging a second portion of the first precursor penetrating through the permeable substrate by a second exhaust portion formed in a second module at another side of the permeable substrate; and
causing relative movement between the permeable substrate and the first and second modules.

14. The method of claim 13, further comprising controlling pressure of the first exhaust portion relative to pressure of the second exhaust portion to adjust first thickness of material deposited on the surface of the substrate relative to second thickness of the material deposited on pores or holes of the substrate.

15. The method of claim 14, wherein the pressure of the first exhaust portion is set higher than the pressure of the second exhaust portion.

16. The method of claim 12, further comprising:
injecting a second precursor by a third module placed adjacent to the first reactor, the second precursor reacting with the first precursor to deposit material on the permeable substrate; and
discharging a first portion of the second precursor flowing along the surface of the permeable substrate by a third exhaust portion formed in the third module.

17. The method of claim 16, further comprising:
discharging a second portion of the second precursor penetrating through pores or holes of the substrate by a fourth exhaust portion formed in a fourth module placed at the other side of the permeable substrate; and
setting pressure at the third exhaust portion and pressure at the fourth exhaust portion to adjust first thickness of the material deposited on the surface of the substrate relative to second thickness of the material deposited on the pores or holes of the substrate.

18. The method of claim 12, further comprising:
injecting a second precursor by a third module placed at the other side of the permeable substrate, the second precursor reacting with the first precursor to deposit material on the permeable substrate; and
discharging a first portion of the second precursor flowing along the other surface of the permeable substrate by a third exhaust portion formed in the third module.

19. The method of claim 18, further comprising:
discharging a second portion of the second precursor penetrating through pores or holes of the substrate by a fourth exhaust portion formed in a fourth module placed adjacent to the first module; and
setting pressure at the third exhaust portion and pressure at the fourth exhaust portion to adjust first thickness of the material deposited on the surface of the substrate relative to second thickness of the material deposited on the pores or holes of the substrate.

20. The method of claim 13, further comprising causing a relative movement between the first and second modules in a direction parallel to the surface of the permeable substrate to control a thickness of the material deposited in the pores or holes of the permeable substrate relative to a thickness of the material deposited on the surface of the permeable substrate.
